(19) United States
(12) Patent Application Publication
(10) Pub. No.: US 2018/0268424 A1
(43) Pub. Date: Sep. 20, 2018

(54) RECORDING AND TRACKING SYSTEM FOR HOME INVENTORY

(71) Applicant: Roy Carl Burmeister, Davisburg, MI (US)

(72) Inventor: Roy Carl Burmeister, Davisburg, MI (US)

(21) Appl. No.: 15/460,295

(22) Filed: Mar. 16, 2017

(51) Int. Cl. G06Q 30/02; G06Q 10/08

(52) U.S. Cl. CPC G06Q 30/0201; G06K 7/1413; G06Q 30/0255; G06Q 10/087

(57) ABSTRACT

A recording and tracking system for tracking and transmitting product information from point-of-use to a retailer. The recording and tracking system comprises a product scanning device outputting scanned product data in response to detected disposal of a product at the point-of-use; a data recording device operably receives the scanned product data and analyzes the scanned product data to determine and output analyzed product data; and a communications server receives the analyzed product data and determines desired product data, the communications server transmits the desired product data to a product supplier.

### FIELD

The present disclosure relates to a recording and tracking system for home inventory and, more particularly, a system to record and track consumer product information from point-of-use to retailer and back to consumer for the purpose of managing home inventory and marketing consumer goods based upon patterns of usage.

### BACKGROUND AND SUMMARY

This section provides background information related to the present disclosure which is not necessarily prior art. This section provides a general summary of the disclosure, and is not a comprehensive disclosure of its full scope or all of its features.

The current state of grocery and sundry retailing involves one of two modes. The first or traditional mode whereby consumers travel to a brick-and-mortar store to replenish consumed supplies by selecting them from stocked shelves and displays. Goods are then purchased and transported back to the home by the consumer. The second or web-based mode, which has gained limited acceptance, is shopping via a store's website, then either having the goods shipped to the consumer's location or by the consumer collecting them at a pre-arranged time and place.

The retailer's role in the traditional mode is passive, communicating product information through display, advertisement, and product placement. The web-based mode is slightly more active, where the consumer is subjected to display and product placement via various web pages, pop-up ads, border advertising, and other common web marketing strategies. The flow of product information in both of these scenarios is primarily one-way—from retailer to consumer, although sales tracking provides the retailer with a means to gage consumer interest in various products. Both modes take considerable time to accomplish by the consumer, and neither is viewed as the ideal.

Before the turn of the previous century, groceries were purchased more or less piecemeal from small specialty stores. With a retail space rarely exceeding a thousand square feet and a staff consisting of an employee or two, the typical grocery store was hardly recognizable by today's standards. Dry groceries, such as dried grains and canned goods, occupied floor to ceiling shelves behind a long counter where items selected by the customer would be retrieved by a knowledgeable grocer with a ladder. Bulk goods, such as rice, beans, and other grains, were sold by the pound, measured out, and packaged for the short trip home. Perishable goods were either not stocked or perhaps offered on a very limited basis. Home delivery was available within certain distance limitations.

Over the ensuing years, several of these small grocery operations grew and evolved into what we have today, largely through expansion brought on by competition, as well as through acquisition and merger of smaller firms into larger ones. Two large well known retailers, Safeway and Kroger, grew along these lines, becoming powerhouses in the retail distribution of food and sundries and capturing an impressive share of the market.

According to the principles of the present teachings, a recording and tracking system for home inventory is provided having advantageous construction and method of use. Generally, in some embodiments, the recording and tracking system is operable to record and track consumer product information from point-of-use to retailer and back to consumer for the purpose of managing a home inventory of products and marketing consumer goods based upon patterns of usage. In some embodiments, the recording and tracking system is operable to improve the means with which home grocery and sundry inventory is managed. Generally, through real-time data collection at point-of-use, such as via scanning product information directly from product packaging, and bi-directional data flow between grocer and consumer, value is generated through reduced cost and improved efficiency for busy shoppers or those who find traditional grocery shopping to be inconvenient or impossible.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic flowchart illustrating the recording and tracking system of the present teachings highlighting the data flow from the point of use (package disposal) through the components of the system to the manufacturer/distributer and back to the consumer.

FIG. 2 is a schematic view illustrating the recording and tracking system of the present teachings according to some embodiments.

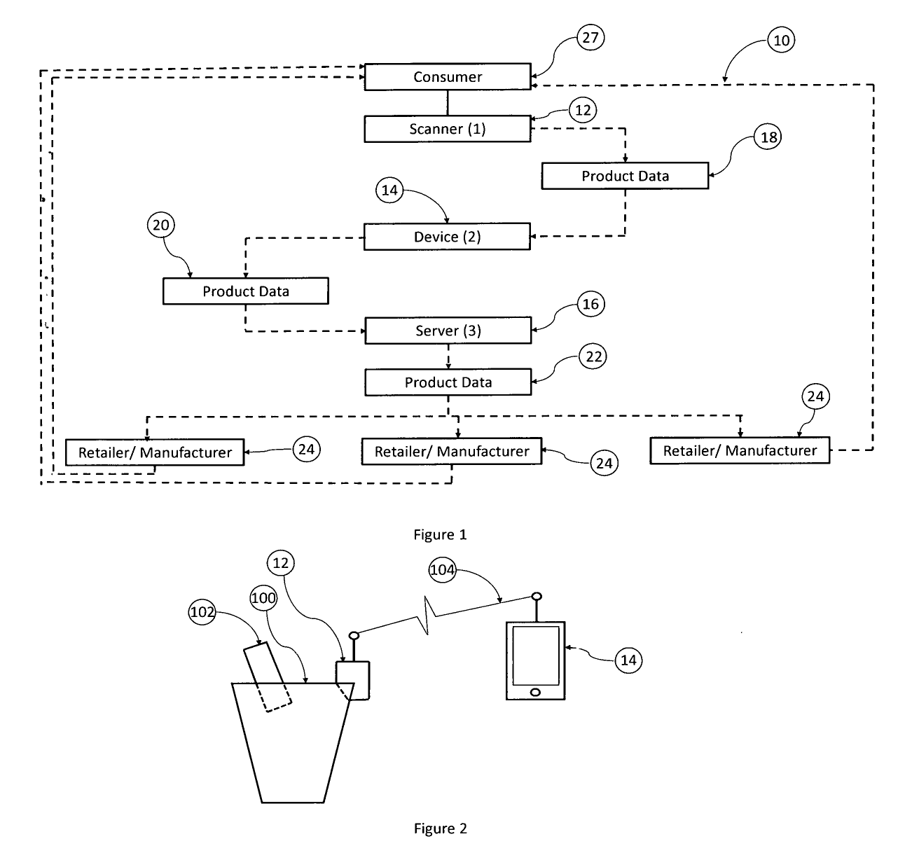

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

According to the principles of the present teachings, a recording and tracking system 10 for home inventory is provided having advantageous construction and method of use. In particular, in some embodiments, the recording and tracking system 10 is operable to record and track consumer product information from point-of-use to retailer and back to consumer for the purpose of managing a home inventory of products and marketing consumer goods based upon patterns of usage. In some embodiments, recording and tracking system 10 is operable to improve the means with which home grocery and sundry inventory is managed. Generally, through real-time data collection at point-of-use, such as via scanning product information directly from product packaging, and bi-directional data flow between grocer and consumer, value is generated through reduced cost and improved efficiency for busy shoppers or those who find traditional grocery shopping to be inconvenient or impossible.

The principles of the present teachings are predicated on the concept that customer satisfaction can be assumed and/or predicted by monitoring consumption through compiling and analyzing the data stream created from discarded packaging. By building a dynamic list of items consumed, a home inventory is thus established, with the consumer maintaining control over content and quantity required. The resulting inventory forms the basis for grocery marketing tailored specifically for the individual consumer's preferences, dietary requirements, history, and demographic. Together, these two principles drive convenience for the consumer, and change traditional cost drivers in the grocery industry, which is a bonus for grocer and consumer alike.

In some embodiments, recording and tracking system 10 comprises a product scanning device 12 operably coupled to a data recording device 14, which operably outputs product data to a communications server 16 for fulfillment. In some embodiments, product scanning device 12 can comprise a bar code scanner, RFID reader, or other product information scanning technology operable to read, detect, or otherwise catalog discarded or otherwise noted retail product. In some embodiments, product scanning device 12 can be a handheld device and/or located on, inside of, attached to, or in close proximity to a waste receptacle or recycling bin. In this way, product scanning device 12 can read, detect, or otherwise catalog consumed products without the need for active operation by a consumer. However, it should be understood that a consumer may opt to manipulate a product scanning device 12 to particularly read, detect, or otherwise catalog a particular product or products.

In some embodiments, product scanning device 12 comprises a camera detector for detecting a bar code image or other trackable indicia, an RFID reader for detecting an RFID transmitter, or other reading system. Product scanning device 12 can comprise a mountable or handheld structure for placement or use in a convenient location, such as, but not limited to, near, adjacent, inside, or in close proximity to a waste receptacle, a recycling receptacle, a food storage location, a refrigerator or freezer, a pantry, and the like. Accordingly, product scanning device 12 can comprise a personal device, such as a smartphone or other reader. In some embodiments, product scanning device 12 can output an audible, visible, or tactile signal indicating proper and/or successful scanning of the consumed product.

In some embodiments, product scanning device 12 can be operably coupled to data recording device 14 via any known connection method. That is, in some embodiments, product scanning device 12 can be coupled to data recording device 14 via a wired connection, such as via internal circuits within a common house resulting in product scanning device 12 and data recording device 14 being an integral device. Product scanning device 12 and data recording device 14 can employ any known wired communication protocol. It should be understood that product scanning device 12 can comprise internal, on-board volatile memory that can, at least temporarily, maintain an internal recording of the read, detected, or otherwise cataloged products and transfer this recording to data recording device 14 at a later time via wired/wireless connection.

In some embodiments, product scanning device 12 and data recording device 14 can be operably coupled via a wireless connection, such as BlueTooth, Wi-Fi, cellular, or other wireless protocol.

In some embodiments, data recording device 14 can comprise any one of a number of computing and/or processing systems, such as, but not limited to, a smart phone, a tablet, or personal computer.

Product scanning device 12 transmits scanned product data 18 to data recording device 14, whereby data recording device 14 records the product data 18 into various predetermined fields. The fields can contain product information that enable the consumer and/or retainer to sort or otherwise better understand, using a software application running on data recording device 14 in non-volatile memory, the consumer's current, past, and/or projected future product needs. This data can be displayed and/or outputted as analyzed product data 20.

Analyzed product data 20 can be transmitted to one or more product suppliers 24, such as retailers, distributors, wholesalers, manufacturers, and the like, in the form of desired product data 22, for a replacement quote and to be mined and analyzed for the purpose of suggesting alternate products based upon usage patterns of the specific consumer.

It should be understood that, in some embodiments, desired product data 22 can be identical to or differ from analyzed product data 20. In this way, consumer 26 can elect to share all analyzed product data 20, including consumer's current, past, and projected future product needs, with retailer/manufacturer 24 to provide the most comprehensive dataset for analysis by retainer/manufacturer 24. However, in some embodiments, desired product data 22 can differ from analyzed product data 20, thereby permitting consumer 26 to retain at least a portion of the data associated with their product consumption and/or usage needs. Nonetheless, desired product data 22 can be transmitted to distributers, manufacturers, and their suppliers 24 to be utilized to identify trends and project demand

### Exemplary Embodiments

In one embodiment, as illustrated in FIG. 2, an RFID reader 12 is attached to a waste receptacle 100, such that product packaging 102 being thrown away is read and the resulting scanned data 18 is transmitted via Bluetooth signal 104 to data recording device 14. In this way, the waste receptacle 100 can be shielded such that no information can be read by RFID reader 12 until the discarded product packaging 102 is placed into the receptacle 100. In this embodiment, data recording device 14 is a tablet running an application that receives scanned product data 18 and catalogs the data by fields in a spreadsheet-like application. The scanned product data 18 is then sorted and analyzed by the application as analyzed product data 20, and analyzed product data 20 or desired product data 22 is then sent at a predetermined interval, such as nightly, to distributer 24 chosen to receive the product information. The distributer 24 can compare the product information against the information on products it sells and formulates a quote for replenishment of the items generated by the discarded packaging, along with some alternative products similar to those on the original list. In some embodiments, distributer 24 may automatically replenish any required product needed.

In another embodiment, a bar code scanner 12 is installed on the door of a cabinet containing the waste receptacle 100. The consumer must pass discarded product packaging 102 near enough to the scanner 12 for the product information to be read by the scanner 12. Once read, an audible signal sounds or a light is illuminated to inform the consumer 26 that the information has been recorded and the packaging is then discarded into the waste receptacle 100. The scanned product data 18 is then transmitted to data recording device 14 running software that compiles a list of products thus consumed. The list is periodically reviewed by the consumer and then sent to subscribing distributors for quote and subsequent replenishment.

Tailored Ordering

In some embodiments, recording and tracking system 10 can be used to simplify assembly of necessary ingredient for a recipe. In this way, a recipe can be scanned, such as via optical character recognition, bar code, or other means, to general a list of ingredients. Recording and tracking system 10 can then be used to assemble a list of ingredients and include the necessary ingredients within the analyzed product data 20 and/or desired product data 22. In the end, considerable time is saved by busy consumers, who are now able to plan and serve meals within their economic and dietary requirements. For example, information from items consumed that meet some dietary requirement, such as low-fat, low sodium, kosher, halal, diabetic, gluten free, and many other categories can be used to tailor offerings that also meet these same requirements. Other examples include sustainably produced or harvested, organic, and local foods. Budget minded consumers might appreciate offerings that stay within a certain monetary threshold, or searches that find the lowest price for items from a list of local retailers.

Although there are numerous benefits to a consumer in connection with the present teachings, it should also be understood that there are several benefits for retailers, including, but not limited to, considerable energy savings realized by not having to maintain open refrigerated displays, use bright lighting designed to enhance the appearance of foods, or provide separate brick-and-mortar stores throughout a community. Considerable labor can be avoided by not having to continually face displays (pulling product forward on shelves to make them appear full), and check-out requires no labor because the transaction is accomplished online.

The present teachings also give retailers the opportunity to market higher margin items in a more active way, thus increasing their profits. One method would be offering meal planning, where chosen meals generate a recipe and order the necessary ingredients. Another embodiment might provide a recipe tailored to the results of a product search, or from information gathered from the items already consumed

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A recording and tracking system for tracking and transmitting product information from point-of-use to a retailer, the recording and tracking system comprising:
a product scanning device outputting scanned product data in response to detected disposal of a product at the point-of-use;
a data recording device operably receiving the scanned product data and analyzing the scanned product data to determine and output analyzed product data; and
a communications server receiving analyzed product data and determining desired product data, the communications server transmitting the desired product data to a product supplier.
